(19) United States
(12) Patent Application Publication
(10) Pub. No.: US 2016/0212071 A1
(43) Pub. Date: Jul. 21, 2016

(54) METHOD, SET OF MACHINE READABLE INSTRUCTIONS, AND COMPUTING SYSTEM ADAPTED FOR SERVICE AUTO RESPONSE GENERATION BASED UPON SOCIAL MEDIA POSTING

(71) Applicant: 44LAB5, LLC, La Plata, MD (US)

(72) Inventors: Luke H. Hannah, La Plata, MD (US); Joseph D. Wilson, Hughesville, MD (US); Thomas E. Hannah, Chesterfield, MO (US)

(73) Assignee: 44LAB5, LLC, La Plata, MD (US)

(21) Appl. No.: 14/997,298

(22) Filed: Jan. 15, 2016

Related U.S. Application Data
(60) Provisional application No. 62/105,770, filed on Jan. 21, 2015.

(51) Int. Cl. H04L 12/58; G06F 17/30

(52) U.S. Cl. CPC H04L 51/02; G06F 17/30528; G06F 17/3053; G06F 17/30867; H04L 51/32

(57) ABSTRACT

An example method, a set of machine readable instructions and associated data stored on a storage device, and a computer system, each adapted for service auto-response generation based upon social media posting, are described herein. In the method, a social media source is continually scrubbed to search for a social media posting posted by a poster thereon. Metadata in the social media posting is analyzed, and a score is calculated based on the analyzed metadata. The calculated score is compared to filter criteria, and, on condition that the score passes the filter criteria, a subscribing client selected from a group of subscribing clients is assigned to generate an auto-response to the poster so as to initiate contact therewith, the generated auto-response addressing content in the social media posting.

### CROSS-REFERENCE TO RELATED APPLICATIONS

The present application claims the benefit under 35 U.S.C. §119(e) of U.S. Provisional Patent Application Ser. No. 62/105,770 to Luke H. Hannah, et al., filed Jan. 21, 2015, pending. The entire contents of this provisional application is hereby incorporated by reference herein.

### BACKGROUND

1. Field

The example embodiments in general are directed to a method, to a set of machine readable instructions and associated data stored on a storage device, and to a computer system, each adapted for service auto-response generation based upon social media posting.

2. Related Art

Online social networks enable users of a social media platform to communicate with one another both publicly and privately. Users may communicate with friends, strangers and businesses. For example, many businesses have Twitter and Facebook accounts that enable the businesses to interact with their customers and/or potential customers. Businesses may use social networks to advertise products, services, or promotions and/or respond to users' questions and complaints.

Advertisements on a social media platform may be targeted to particular users based on the users' activities on the social media platform. The advertisements are generally created in advance and displayed to hundreds or thousands of users.

Businesses also use customer relationship management (CRM) software to manage clients and potential customers. Marketing teams may use CRM software to track leads and communications with potential customers over a time frame of weeks, months and years. However, these advertising campaigns and potential customer lead management using CRM software is relatively slow and prevents a business from reacting in real time to a potential customer's needs.

In general, the phrase “social media” may be understood as the use of Web-based and mobile technologies to turn communication into an interactive dialogue. Andreas Kaplan and Michael Haenlein define social media as “a group of Internet-based applications that build on the ideological and technological foundations of Web 2.0 and that allow the creation and exchange of user-generated content.” (See, Kaplan, Andreas M.; Michael Haenlein (2010); Users of the world unite!—The challenges and opportunities of Social Media; Business Horizons 53 (1): 59-68).

As previously noted, social media is for social interactions. Enabled by ubiquitously accessible and scalable communication techniques, social media has substantially changed communication between organizations, communities, as well as between individuals. Social media may take on many different forms, such as Internet forums, Weblogs, social blogs, micro-blogging, wikis, podcasts, photographs or pictures, video, rating, and social bookmarking. By applying a set of theories in the field of media research, e.g., social presence, media richness, and social processes, e.g. self-presentation, self-disclosure, Kaplan and Haenlein (ibid) created a classification scheme for different social media types. According to Kaplan and Haenlein, there are six different types of social media: collaborative projects, e.g. Wikipedia, blogs and micro-blogs, e.g., TWITTER®, content communities, e.g., YOUTUBE®, social networking sites, e.g., FACEBOOK®, LINKED IN® ,virtual game worlds, e.g., WORLD OF WARCRAFT®, and virtual social worlds, e.g., SECOND LIFE®. Technologies include: blogs, picture-sharing, vlogs, wall postings, email, instant messaging, music-sharing, crowd-sourcing, voice over IP, and the like. Many of these social media services can be integrated via social network aggregation platforms.

Kietzmann et al. (see Kietzmann, Jan H.; Kris Hermkens, Ian P. McCarthy, and Bruno S. Silvestre (2011); Social media? Get serious! Understanding the functional building blocks of social media; Business Horizons 54 (3): 241-251) present a honeycomb framework that defines how social media services focus on some or all of seven functional building blocks: identity, conversations, sharing, presence, relationships, reputation, and groups. These building blocks help understand the engagement needs of the social media audience. For instance, LinkedIn users care mostly about identity, reputation, and relationships, whereas YouTube's primary building blocks are sharing, conversations, groups, and reputation.

Kietzmann et al. (ibid) contend that social media presents an enormous challenge for firms, as many established management methods are ill-suited to deal with customers who no longer want to be talked at, but who want firms to listen, appropriately engage, and respond. The authors explain that each of the seven functional building blocks has important implications for how firms should engage with social media. By analyzing identity, conversations, sharing, presence, relationships, reputation and groups, firms can monitor and understand how social media activities vary in terms of their function and impact, so as to develop a congruent social media strategy based on the appropriate balance of building blocks for their community.

It has been observed that Facebook is now the primary method for communication by college students in the U.S. There are various statistics that account for social media usage and effectiveness for individuals worldwide. Some of the most recent statistics include: (i) a new study reveals that internet users in 2014 now spend a daily average of 6.09 hours on online media, and more than one full quarter of all that time that is used by social networking on platforms such as FACEBOOK, TWITTER, SNAPCHAT® and INSTAGRAM®. GLOBALWEB INDEX™ surveyed internet users aged 16-64 and found that 28 percent of all time spent online as of April 2014 is consumed by social media, which equates to about 1.69 hours each and every day; (ii) COMSCORE®, Inc., a leader in measuring the digital world, released data from their MOBILENS® and MOBILE METRIX®, reporting key trends in the U.S. smartphone industry for July 2014. These reports indicate that 173 million people in the U.S. owned smartphones (71.8 percent mobile market penetration) during the three months ending in July 2014; (iii) As of December 2014, TWITTER had more than 500 million users, out of which more than 284 million were active users. Every second, on average, around 6,000 tweets are tweeted on TWITTER, which corresponds to over 350,000 tweets sent per minute, 500 million tweets per day and around 200 billion tweets per year. However, the number of twitter active users is now dwarfed by INSTAGRAM, whose CEO Kevin Systrom told the BBC in December 2014 that “monthly active users of the service now total upwards of 300 million.”; (iv) As part of its financial results for its 2013 fourth quarter, Facebook announced that its social network passed 1.23 billion monthly active users. Of those, daily active users passed 757 million on average during December 2013, and the number of monthly active mobile users hit 945 million.

“Social Media Revolution”, produced by Socialnomics author Erik Qualman, contains numerous statistics on social media, including the fact that 93% of businesses use it for marketing and that if Facebook were a country, it would be the third largest. In an effort to supplant FACEBOOK's dominance, GOOGLE® launched GOOGLE+® in the summer of 2011.

Using social media as a form of marketing has thus taken on a whole new set of challenges. The 2013 Nielsen Global Trust in Advertising and Messages report, which polls over 29,000 consumers in 58 countries, notes that although recommendations from friends and family and consumer opinions posted online remain the most trusted form of messaging, online and mobile advertising formats reported some of the biggest increases in trust since Nielsen's 2007 report. Accordingly, advertisers are exhibiting growing confidence in these formats; while companies are unable to directly control their messaging in earned media (such as consumer opinions posted online), they have the ability to create a positive presence for their brands on these channels.

As the 2013 Nielsen Trust study indicates, it is most effective if marketing efforts through social media revolve around the genuine building of trust. Someone performing a marketing role within a company must honestly convince people of their genuine intentions, knowledge, and expertise in a specific area or industry through providing valuable and accurate information on an ongoing basis without a marketing angle overtly associated.

### SUMMARY

An example embodiment of the present invention is directed to a method in which a social media source is continually scrubbed to search for a social media posting posted by a poster thereon. Metadata in the social media posting is analyzed, and a score is calculated based on the analyzed metadata. The calculated score is compared to filter criteria, and, on condition that the score passes the filter criteria, a subscribing client selected from a group of subscribing clients is assigned to generate an auto-response to the poster so as to initiate contact therewith, the generated auto-response addressing content in the social media posting. The scrubbing, analyzing, calculating, comparing, and assigning steps are performed by computer software adapted to run on computer hardware.

Another example embodiment is directed to a set of machine readable instructions and associated data stored on a storage device in a manner more persistent than a signal in transit. The set includes a fetch posting module programmed to continually scrub a social media source to search for a social media posting posted by a poster thereon, and an analysis module programmed to analyze metadata of the social media posting, calculate a score based on the analyzed metadata, the score being related to whether the social media posting passes filter criteria. The analysis module is further programmed to compare the calculated score to the filter criteria, and, on condition that the score passes the filter criteria, an assignment module is programmed to assign a subscribing client selected from a group of subscribing clients to generate an auto-response to the poster so as to initiate contact therewith, the generated auto-response addressing content in the social media posting.

Another example embodiment is directed to a computer system that includes a processing hardware set, and a computer readable storage device medium. The processing hardware set is structured, connected and/or programmed to run program instructions stored on the computer readable storage medium instructions and associated data. The program instructions include a fetch posting module programmed to continually scrub a social media source to search for a social media posting posted by a poster thereon, and an analysis module programmed to analyze metadata of the social media posting, and calculate a score based on the analyzed metadata, the score being related to whether the social media posting passes filter criteria. The analysis module is further programmed to compare the calculated score to the filter criteria, and, on condition that the score passes the filter criteria, an assignment module is programmed to assign a subscribing client selected from a group of subscribing clients to generate an auto-response to the poster so as to initiate contact therewith, the generated auto-response addressing content in the social media posting.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 is a pictorial flow diagram to describe in general terms a method that is adapted for service auto-response generation based upon a social media posting.

FIG. 2 illustrates an exemplary computer system in accordance with some embodiments.

FIG. 3 is a simplified block diagram of an exemplary computing device of some embodiments.

FIG. 4 is a flow diagram to describe a method for service auto-response generation based upon a social media posting according to the example embodiments.

FIG. 5 is a flowchart illustrating selected steps of the method described in FIG. 4 in more detail.

FIG. 6 is a heat map illustrating geolocation principles of the exemplary method.

FIG. 7 is another heat map illustrating geolocation principles of the exemplary method.

FIG. 8 is a picture of a chat box illustrating an example post on TWITTER evaluated by the SCRBR algorithm.

FIG. 9 is picture of a chat box illustrating an example auto-generated response by the subscriber client selected or assigned by the SCRBR algorithm to address the post in FIG. 8.

FIG. 10 is a picture of a chat box illustrating another example post evaluated by the SCRBR algorithm.

FIG. 11 is picture of a chat box illustrating an example auto-generated response by the subscriber client selected or assigned by the SCRBR algorithm to address the post in FIG. 10.

FIG. 12 is a screenshot of another timeline example using the SCRBR application to address separate burst pipe and broken windshield tweets.

FIG. 13 is a graph of a one month snapshot of tweets in spring 2015 which include duct/vent cleaning keywords therein, as tracked by an analytics vendor.

FIG. 14 is a graph of a one month snapshot of tweets in spring 2015 which include fire damage-related keywords therein, as tracked by the analytics vendor.

FIG. 15 is a graph of a one month snapshot of tweets in spring 2015 which include Paleo-related keywords therein, as tracked by the analytics vendor.

FIG. 16 is a graph of a one month snapshot of tweets in spring 2015 which include water damage-related keywords therein, as tracked by the analytics vendor.

FIG. 17 is a graph of a one month snapshot of tweets in spring 2015 which include windshield damage-related keywords therein, as tracked by the analytics vendor.

### DETAILED DESCRIPTION

As will be appreciated by one skilled in the art, the example embodiments of the present invention may be embodied as a system, method, set of machine readable instructions and associate data in a manner more persistent than a signal in transit, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

In yet another embodiment, the computing system(s), method(s) and computer program product(s) as described in the example embodiments can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of the example embodiments.

Exemplary hardware that can be used for the example embodiments includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus or device, or any suitable combination of the foregoing. A non-exhaustive list of specific examples for a computer-readable storage medium would include at least the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In the context of this document, a computer-readable storage medium may be any tangible medium that can contain or store a program for use by or in connection with an instruction execution system, apparatus or device. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Accordingly, the present invention foresees that a non-transitory computer readable information storage media having stored thereon information, that, when executed by a processor, causes the steps described in more detail hereafter in the example method(s) to be performed.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including but not limited to wireless, wireline, optical fiber cable, RF, etc., or any suitable combination of the foregoing.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

Computer program code for carrying out operations for aspects or embodiments of the present invention may be written in any combination of one or more programming languages, including an object oriented programming language such as JAVA®, SQL™, PHP™, RUBY™, PYTHON®, JSON, HTML5™, OBJECTIVE-C®, SWIFT™, XCODE®, SMALLTALK™, C++ or the like, conventional procedural programming languages, such as the “C” programming language or similar programming languages, any other markup language, any other scripting language, such as VBScript, and many other programming languages as are well known may be used.

The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet using an Internet Service Provider).

Embodiments and aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the embodiments described herein can be implemented on a computer having a display device, e.g., a CRT (cathode ray tube) LED (light emitting diode), or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The computer system can include clients and servers. A client and server are generally remote from each other and typically interact over a communication network. The relationship of client and server arises by virtue of computer programs running on the respective computers and having a client-server relationship to each other.

As used herein, the terms “program” or “software” are employed in a generic sense to refer to any type of computer code or set of computer-executable instructions that can be employed to program a computer or other processor to implement various aspects of the present invention as discussed above. Additionally, it should be appreciated that one or more computer programs that when executed perform methods of the example embodiments need not reside on a single computer or processor, but may be distributed in a modular fashion amongst a number of different computers or processors to implement various aspects of the example embodiments.

Computer-executable instructions may be in many forms, such as program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

As used herein, the term “post” refers in general to a message posted in any online forum or newsgroup. When referring to a message board, a post refers to an article published on an Internet newsgroup, forum, or other bulletin board area. It is also the act of publishing such a message.

As used herein, the term “tweet” refers in general to a post made on the TWITTER® online message service. A tweet is an online posting, or “micro-blog” created by a Twitter user. The purpose of each tweet is to answer the question, “What are you doing?” However, tweets can contain any information the poster (user) wants to post, such as plans for the weekend, thoughts about a TV show, or even notes from a lecture. The poster can publish a tweet using a computer or a mobile phone. Once published, the tweet will appear on the TWITTER home pages of all the users that are following the poster. Likewise, the poster's TWITTER home page will display the most recent tweets of users that the poster is following. Since each tweet is limited to 140 characters or less, it possible to show several tweets on one page without certain tweets taking up substantially more space than others.

As used herein, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, any kind of database object described herein can be implemented as single databases, a distributed database, a collection of distributed databases, a database with redundant online or offline backups or other redundancies, etc., and might include a distributed database or storage network and associated processing intelligence.

As used herein, the phrase “present invention” should not be taken as an absolute indication that the subject matter described by the term “is covered by either the claims as they are filed, or by the claims that may eventually issue after patent prosecution; while the term “present invention” is used to help the reader to get a general feel for which disclosures herein are believed as maybe being new, this understanding, as indicated by use of the term “present invention,” is tentative and provisional and subject to change over the course of patent prosecution as relevant information is developed and as the claims are potentially amended.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise.

As used in the specification and appended claims, the terms “correspond,” “corresponds,” and “corresponding” are intended to describe a ratio of or a similarity between referenced objects. The use of “correspond” or one of its forms should not be construed to mean the exact shape or size.

In the drawings, identical reference numbers identify similar elements or acts. The size and relative positions of elements in the drawings are not necessarily drawn to scale.

As will be described in more detail hereafter, the example method, non-transitory computer readable information storage media, set of machine readable instructions and associated data stored in a storage device, computer system, and computing device are configured to evaluate social media sources in order to match up a subscriber client with a poster to address a problem or issue of the poster. Social media sources in general include any social media website in which one has access to the application program interface (API) of the website. As is well known, the API is a set of routines, protocols, and tools for building software applications. The API specifies how software components should interact and are used when programming graphical user interface (GUI) components.

Social media sources include social networking platforms or websites including but not limited to FACEBOOK®, TWITTER®, LINKED IN®, MYSPACE®, FRIENDSTER® and TUMBLR®, that allow individuals to post updates and make comments that are immediately shared with others. Social media sources also include platforms or websites such as INSTAGRAM®, FLICKR®, PINTEREST® and YOUTUBE® that allow users to post video and image content. In some cases, posts are “public,” meaning publicly accessible; in other cases, posts are “private,” meaning that such posts are shared only with pre-authorized individuals.

As examples, a post includes a user-generated post of text data. Messages include text created by a user, and may include other data as well. Examples of messages include posts such as tweets, user status updates, and comments. Messages can be created for a user's profile or for a record. Posts can be created by various users, potentially any user, although some restrictions can be applied. As an example, posts can be made to a wall section of a user's profile (which can include a number of recent posts) or a section of a record that includes multiple posts. The posts can be organized in chronological order when displayed in a graphical user interface (GUI). In one implementation, a comment can be made on any post. In another implementation, comments are organized as a list explicitly tied to a particular post.

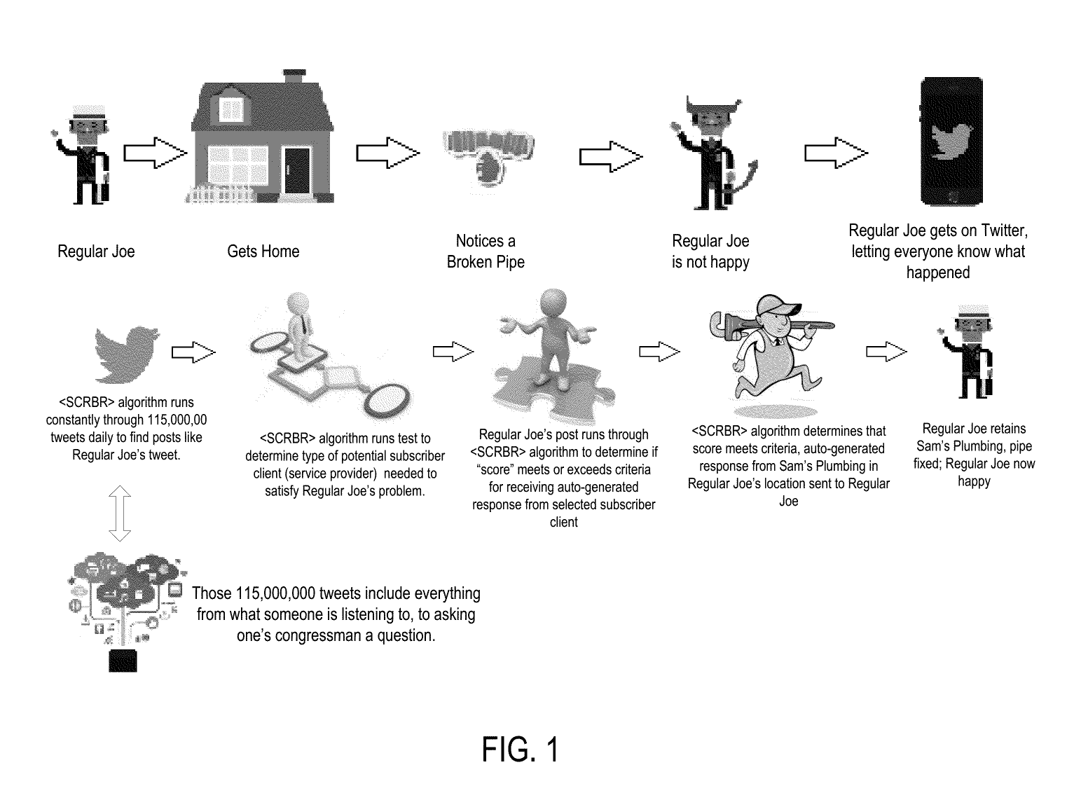

FIG. 1 is a pictorial flow diagram to describe in general terms a method that is adapted for service auto-response generation based upon a social media posting. As shown in FIG. 1, a human being (“Regular Joe”) arrives home to find that a water pipe has broken, flooding the area around the break in his house. This upsets Regular Joe, and as he is a user (poster) on a social media website of a distributed social media network, in this particular example a TWITTER user, Regular Joe tweets to let everyone know what just happened.

In general, in an effort to provide an overview of the example method, which may be implemented by a computer system or computing device, and which may be embodied as non-transitory computer readable information storage media or a set of machine readable instructions and associated data stored in a storage device, a metacrawling or data mining-based algorithm, referred to hereafter as a “SCRBR algorithm” continually runs on an application server of the example computer system or computing device to scrub through at least 115,000,000 daily tweets (or posts) (which at the time of the drafting of this disclosure represents the daily number of tweets processed by TWITTER) to search out posts like Regular Joe's tweet. In doing the scrub, the SCRBR algorithm performs at least two simultaneous functions. In general in one instance, the SCRBR algorithm analyzes the metadata in the social media posting (tweet) to determine the type of subscriber client of the SCRBR service (which may be a service provider business entity) required to address Regular Joe's issue.

In another instance, the SCRBR algorithm analyzes the metadata as part of as test in which a score is calculated for the tweet (post), in order to determine whether the social media posting passes a filter criteria, and, on condition that the score passes the filter criteria, a subscriber client is assigned or selected from a group of potential subscriber clients that subscribe to the SCRBR service (i.e., service providers) to generate an auto-response to the poster so as to make direct contact therewith, the generated auto-response addressing content in the social media posting. In this example, the score of Regular Joe's tweet passes the filter criteria and a subscriber client (“Sam's Plumbing”) is assigned by the SCRBR algorithm as being in Regular Joe's location; an auto-generated response therefore being sent in reply to the tweet. Additional details of these functions are described in further detail hereafter.

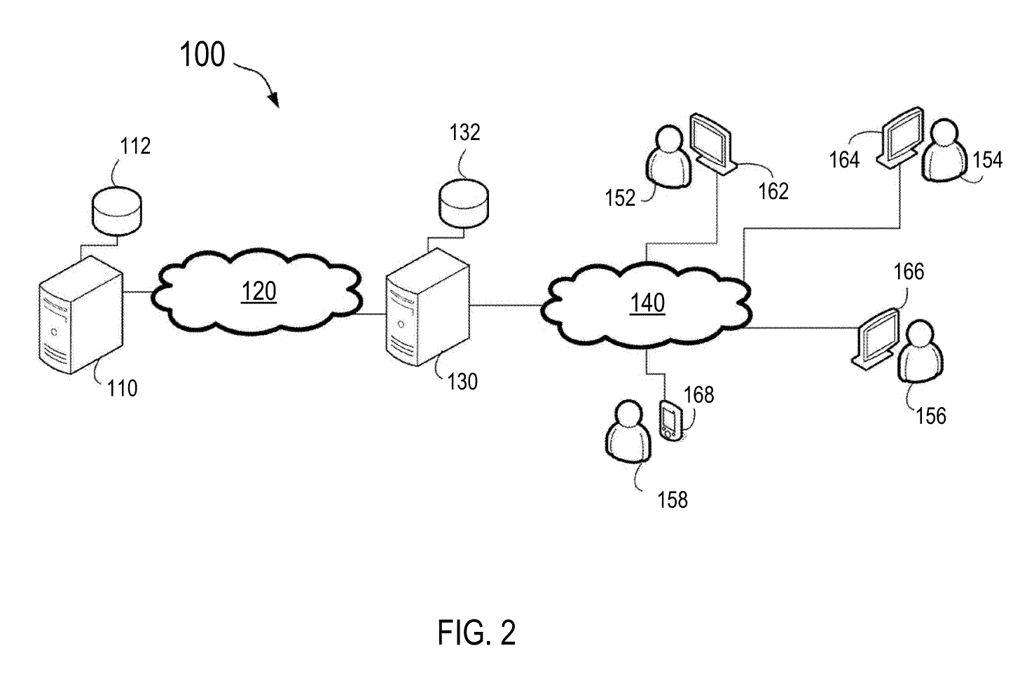

FIG. 2 illustrates an exemplary computer system 100 in accordance with some embodiments. In this example, at least one social media source server 110 is operated by a company that provides a social media source (e.g., website) for users (posters) to form a distributed social network. The at least one server 110 communicates with at least one database 112. The at least one database 112 stores information about users/posters of the social media source. For example, the at least one database 112 may store poster profiles that include a nickname, a real name, an email address, a physical address, a city, a state, a county, and/or a phone number for each poster on the social media source. The at least one database 112 may also store social media content (including metadata) associated with each poster/user of the social media source. In the example were the company operating the server 110 and the database 112 is TWITTER, the social media content may include one or more tweets received from the poster/user in any suitable way. For example, the user may tweet from a mobile telephone or a computer.

In some embodiments, the at least one database 112 may be included as part of the at least one social media source server 110. In other embodiments, the at least one database 112 and the at least one social media source server 110 are separate and communicate over, for example, an intranet or any other suitable network. Embodiments are not limited to any particular social media source architecture.

If more than one social media source server 110 is used, they may be located in close proximity to one another (e.g., in a server farm located in a single building or campus), or they may be distributed at locations remote from one another (e.g., one or more servers located in city A and one or more servers located in city B). As used herein, each social media source server 110 could include one or more logically and/or physically connected servers distributed locally or across one or more geographic locations.

Computer system 100 includes at least one SCRBR application server 130 (hereafter “application server 130”). Application server 130 communicates with at least one database 132. Database 132 stores profile information for the plurality of subscriber clients that subscribe to the SCRBR service. In some embodiments, database 132 may be included as part of the at least one application server 130. In other embodiments, the at least one database 132 and the at least one application server 130 are separate and communicate over, for example, an intranet or any other suitable network. Embodiments are not limited to any particular server architecture.

In some embodiments, database 132 may also store historical information about posters, who represent potential customers for the subscriber clients. For example, if a poster's need is determined based on a portion of the poster's social media content, that need may be stored for future use. In this way, in some embodiments, the at least one application server 130 may build a profile for one or more of the social media source posters (users). The profile may include any suitable information about the posters. A profile may include, for example, historical needs of the poster (as determined by application server 130), times/dates when needs were expressed by the poster, geolocation information about the poster, and flags that indicate the poster is a spammer or some other undesirable type.

The at least one application server 130 receives social media content from the at least one social media source server 110 via network 120. Network 120 may be, for example, the Internet and servers 110 and 130 may communicate over network 120 using at least one network interface.

The at least one application server 130 analyzes the received social media content to determine whether the post of the poster meets or exceeds a criteria to assign a subscriber client (selected from a group of subscriber clients who potentially may be able to address the poster's issue) to the poster for generating an auto-response to the post (tweet). The analysis of the social media content may be done in any suitable way. For example, in some embodiments, natural language processing may be used to extract certain preliminary keywords from the social media content. Natural language processing may further include performing a semantic analysis.

In some embodiments, the geolocation of the poster on the social media source may be determined by application server 130. Geolocation refers to the poster/user's physical location in the world, not a logical location such as the IP address or subnet of the user's computer (though the IP address or subnet of the user may be used to determine the geolocation of the user). A user's geolocation may be determined in any suitable way.

In some embodiments, the geolocation of the poster's home or place of business may be retrieved from their social media source profile. In other embodiments, the geolocation of the poster when a post to a social network is created may be retrieved from the post itself. For example, some social media sources, such as Facebook and Twitter, allow the user's geolocation to be posted along with the social media content based on the global positioning system (GPS) location determined by the user's computing device. Alternatively, the poster may have specified geolocation information in the social media content being analyzed. For example, the content may mention a city, state, or other geolocation information. Accordingly, geolocation information, and any other suitable information, may be determined by analyzing the content of a user's social media posts.

In some embodiments, the at least one application server 130 may also determine a sentiment associated with a user's/poster's social media post. For example, a tweet may express disappointment or anger based on the occurrence of an insurance loss event at the poster's home or automobile. The sentiment of the poster may be used by the at least one application server 130 to determine whether a weighted, calculated “score” reflective of the poster's tweet exceeds a threshold filter criteria. For example, if an example post reads, “I hate my hot water heater, it is always breaking and flooding the basement,” the poster is clearly expressing negative sentiments about his/her hot water heater. Accordingly, it may be concluded that there is a high probability that the poster's calculated weighted score will exceed the threshold filter criteria so as to assign a subscriber client to auto-generate a response addressing the issue or offering repair service. This example demonstrates use of semantic analysis and determining the sentiment of social media content when determining the weighted score of the post (tweet).

Generally, the weighted score calculated by the application server 130 for the post may be determined by taking into account all of the words used in the social media content and determining how they relate to one another. The application server 130 monitors all social media sites to search for certain preliminary keywords found in the analyzed metadata of the post or tweet's content which may describe or relate to a need and/or words expressing a sentiment of the poster in order to calculate the weighted score, determine the type of need and assign the credible subscriber client (in this example a service provider) who is in the location of the poster and can best meet the poster's need.

In some embodiments, in response to determining that a poster may be a potential customer for a subscriber client, the selected/assigned subscriber client may be notified and provided with information about the poster. The subscriber client may be notified in any suitable way. Some embodiments store the notification and poster information in database 132 in a manner that is accessible by the selected/assigned subscriber client. For example, a human 152 associated with the selected/assigned subscriber client may use a computer 162 to connect to the application server 130 via network 140. The notification and/or information about the potential customer (poster) may be accessed by the human 152. In other embodiments, a human 158 associated with the selected/assigned subscriber client may be using a mobile device 168, such as a mobile telephone, tablet, or personal digital assistant (PDA). In some embodiments, the mobile device may be executing a specialized application that gives the human 158 access to the SCRBR service in the cloud. The at least one application server 130 may use push notifications to notify the human 158 in real time when a potential customer (poster) is identified. In other embodiments, the human 158 may be notified using an SMS message or email message received by mobile device 168.

In some embodiments, a computing device 164 may notify a human 154 associated with the selected/assigned subscriber client of the poster in real time by presenting information about the potential customer on a display device of the computing device 164. The human 154 associated with the selected/assigned subscriber client may then respond to the notification by writing and sending a personalized message to the poster using computing device 164. By sending the message to the application server 130, information about the message may be stored in database 132 in association with the SCRBR software. This may allow tracking of the potential customer lead and keep a record of communications with the potential customer for the selected/assigned subscriber client's records.

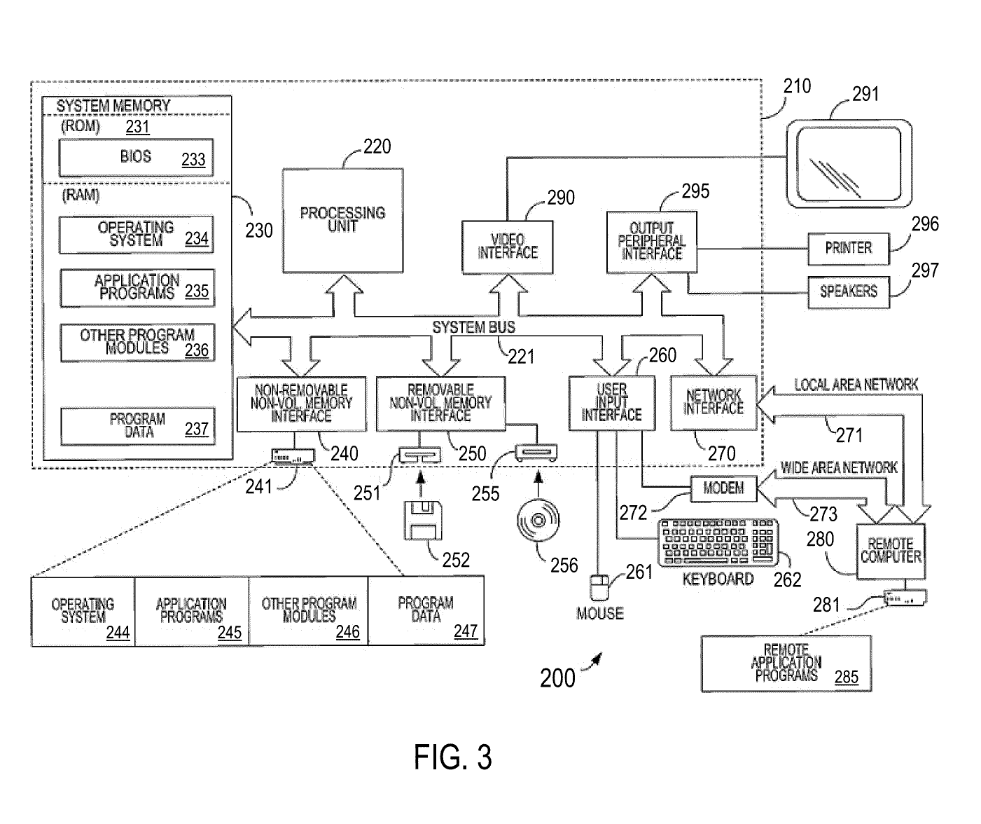

FIG. 3 is a simplified block diagram of an exemplary computing device of some embodiments. With reference to FIG. 3, the exemplary method, non-transitory computer readable information storage media, and set of machine readable instructions and associated data stored in a storage device herein may be implemented by or in a general purpose computing device in the form of a computer 210. Components of computer 210 may include but are not limited to a processing unit 220, a system memory 230, and a system bus 221 that couples various system components including the system memory to the processing unit 220. The processing unit 220 runs computer code run and may be embodied as a central processing unit such as an INTEL® PENTIUM® processor or the like. Similarly, computer 210 and all of its components might be operator-configurable using application(s) including computer code iterated by a central processing unit such as processing unit 220, which may include an INTEL PENTIUM processor or the like, and/or multiple processor units.

The system bus 221 may be any of several types of bus structures including a memory bus or memory controller, a peripheral bus, and a local bus using any of a variety of bus architectures. By way of example and not limitation, such architectures include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnect (PCI) bus also known as a Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EERPOM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 3 illustrates operating system 234, application programs 235, other program modules 236, and program data 237.

The computer 210 may also include other removable/non-removable, volatile/nonvolatile computer storage media. By way of example only, FIG. 3 illustrates a hard disk drive 241 that reads from or writes to non-removable, nonvolatile magnetic media, a magnetic disk drive 221 that reads from or writes to a removable, nonvolatile magnetic disk 222, and an optical disk drive 255 that reads from or writes to a removable, nonvolatile optical disk 226 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 221 and optical disk drive 255 are typically connected to the system bus 221 by a removable memory interface, such as interface 250.

The drives and their associated computer storage media discussed above and illustrated in FIG. 3, provide storage of computer readable instructions, data structures, program modules and other data for the computer 210. In FIG. 3, for example, hard disk drive 241 is illustrated as storing operating system 244, application programs 245, other program modules 246, and program data 247. In one example, the other program modules 246 may include a fetch posting module programmed to continually scrub websites of distributed social media networks to search for a social media posting posted by a poster/user, an analysis module programmed to analyze metadata in the social media posting, to calculate a weighted score related to whether the post passes filter criteria, comparing the calculated score to the filter criteria, and, on condition that the score passes the filter criteria, an assignment module programmed to assign or select a subscriber client (such as a service provider business entity from a group of clients subscribing to the SCRBR service) to generate an auto-response to the poster.

These components may either be the same as or different from operating system 234, application programs 235, other program modules 236, and program data 237. Operating system 244, application programs 245, other program modules 246, and program data 247 are given different numbers here to illustrate that, at a minimum, they are different copies.

Computer 210 may be embodied also as a desktop personal computer, workstation, laptop, PDA, cell phone, or any wireless access protocol (WAP) enabled device or any other computing device capable of interfacing directly or indirectly to the Internet or other network connection. The system may typically run an HTTP client, e.g., a browsing program, such as the INTERNET EXPLORER® browser from MICROSOFT®, FIREFOX® or SAFARI® browsers, or a WAP-enabled browser in the case of a cell phone, PDA or other wireless device, or the like, allowing a subscriber client to access, process and view information, pages and applications available to it from the system over a network, for example. As discussed above, implementations are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

A user may enter commands and information into the computer 210 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through an output peripheral interface 295.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 3. The logical connections depicted in FIG. 3 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 3 illustrates remote application programs 285 as residing on memory device 281. It will be appreciated that the network connections shown are exemplary and other means of establishing a communications link between the computers may be used.

It should be appreciated that FIGS. 2 and 3, taken singly or together, provide only one example implementation (that is, system 100 and computer 210) and does not imply any limitations with regard to the environments in which different embodiments may be implemented. Many modifications to the depicted environments may be made, especially with respect to current and anticipated future advances in cloud computing, distributed computing, smaller computing devices, network communications, and the like.

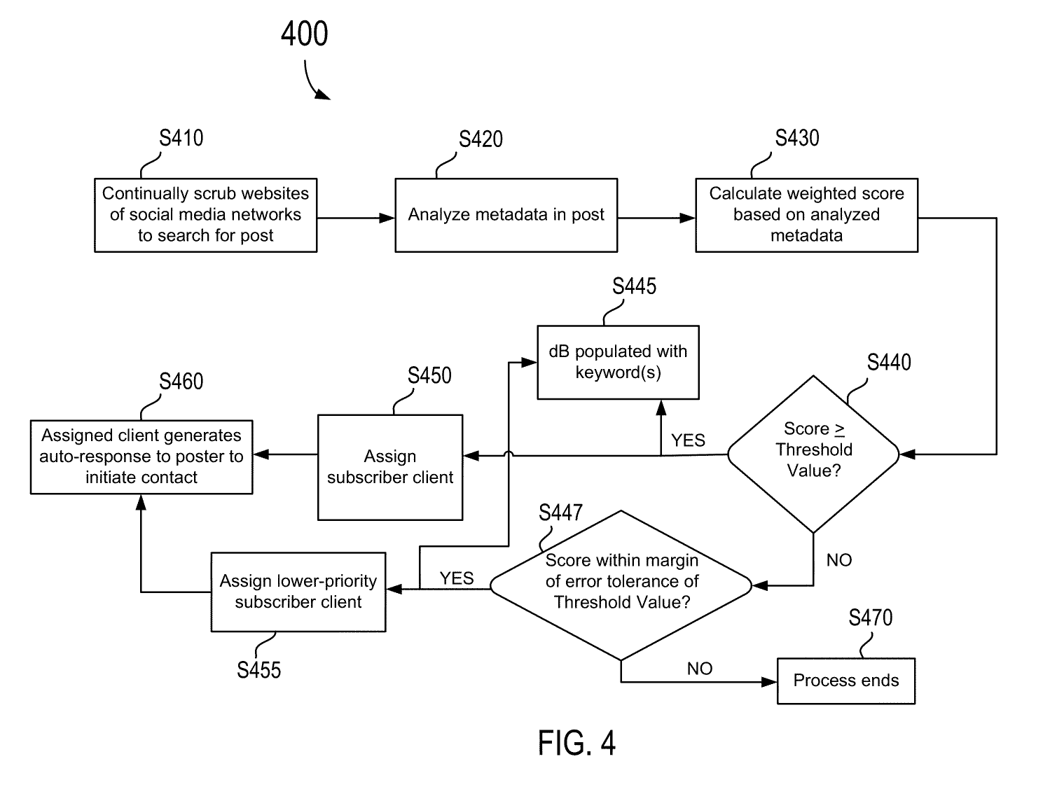

FIG. 4 is a flow diagram to describe a method for service auto-response generation based upon a social media posting according to the example embodiments. There is shown a method 400 by which a subscriber client may generate an auto-response to a post or tweet by a poster (user). In the method 400, one or more websites of distributed social media networks are continually scrubbed (S410) in accordance with the SCRBR algorithm to search for a social media posting posted by a poster (user) on a social media website. In an example, this post may be related to an insurance loss event such as was described in the Regular Joe example of FIG. 1. Insurance loss events may include but are not limited to those events where damage is caused by any of fire, water, sewage, smoke, mold, vandalism, trauma, and structural failures, or due to force majeure conditions such as wind, fallen trees, lightening, earthquakes, hurricanes, snow loads, hail, ice dams and other acts of God. Such damage may be related to home, appliance and/or automobile damage.

The SCRBR algorithm then analyzes metadata of the social media posting (S420) to calculate a weighted score (S430) as to whether the social media posting passes filter criteria. In general, and as to be described in further detail hereafter, analyzing metadata of the social media posting further includes searching for selected or predetermined keywords in the content of the post to evaluate against stored databases of positive and negative keywords that directly affect the calculated score.

In comparing the calculated weighted score to a threshold value representative of the filter criteria, if the calculated score does not meet or exceed this threshold value (output of S440 is “NO”), another margin of error determination (at Step S447) is made based on the calculated strength of the score. In one example, if the score is within the margin of error (i.e., +/−1 point from the threshold value, output of S447 is “YES”), then a lower priority subscriber client may be assigned (Step S455) such as the next client in rotation generate the auto-response to the poster to initiate contact (Step S460). Otherwise (output of S447 is “NO”), the process ends (See Step S470).

In parallel with assigning the lower priority client at S455, the SCRBR database 132 in application server 130 stores the keyword(s) and associated event data (at Step S445) that is tied to the calculated score being within the margin of error. This is done as a predictive measure of a future event reaching another geographical area. For example, if a massive hailstorm has hit the greater Columbia, S.C. metropolitan area on day 1, and SCRBR stores the total number of cracked windshield occurrences in that storm, providing this information might be useful to the subscriber clients, in that it may compel them to alter or widen their geofence in an effort to increase more business. Moreover, the SCRBR algorithm may be further adapted to provide alerts to its subscriber clientele in the event such a storm is headed toward their geofence area (in a day 2 or in subsequent days). The ability to receive meaningful information of an impending insurance loss event based on stored event history may act to enable the client to make a better business decision as to adjusting their geofence.

On the condition that the score passes the filter criteria (output of S440 is “YES”), the SCRBR algorithm assigns or selects (S450) a subscriber client (e.g., service provider) from a group of clients subscribing to the SCRBR service. A service provider may be any service-oriented business entity. Example service provides include, but are not limited to, service-oriented businesses related to any of disaster restoration, auto glass repair, auto repair, home improvement, real estate sales, appliance repairs, and the like. Concurrent with client assignment at S450, and as noted above, database 132 stores the keyword(s) and associated event data (at Step S445) tied to the calculated exceeded the threshold value.

The selected client then generates an auto-response (S460) in reply to the poster's tweet (post) so as to initiate contact therewith. The generated auto-response thus addresses the content in the social media post. As is readily observed, each of the scrubbing, analyzing, calculating, comparing, and assigning steps are adapted to be performed by computer software adapted to run on computer hardware.

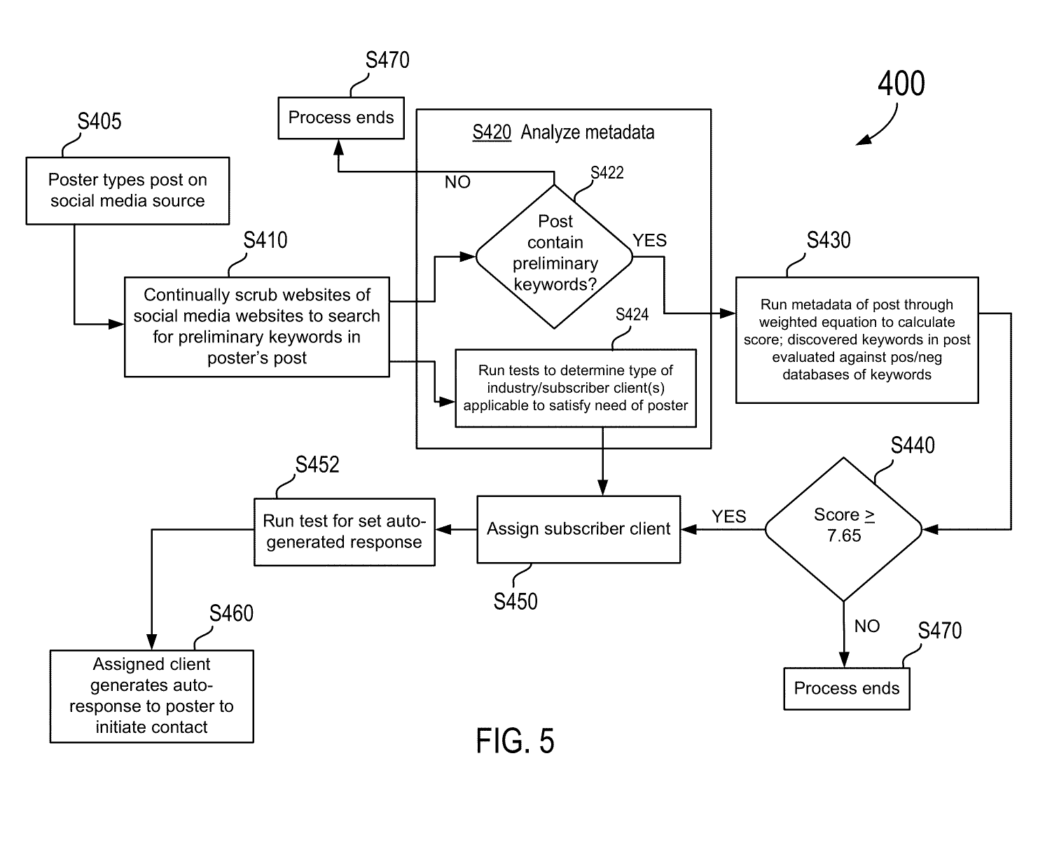

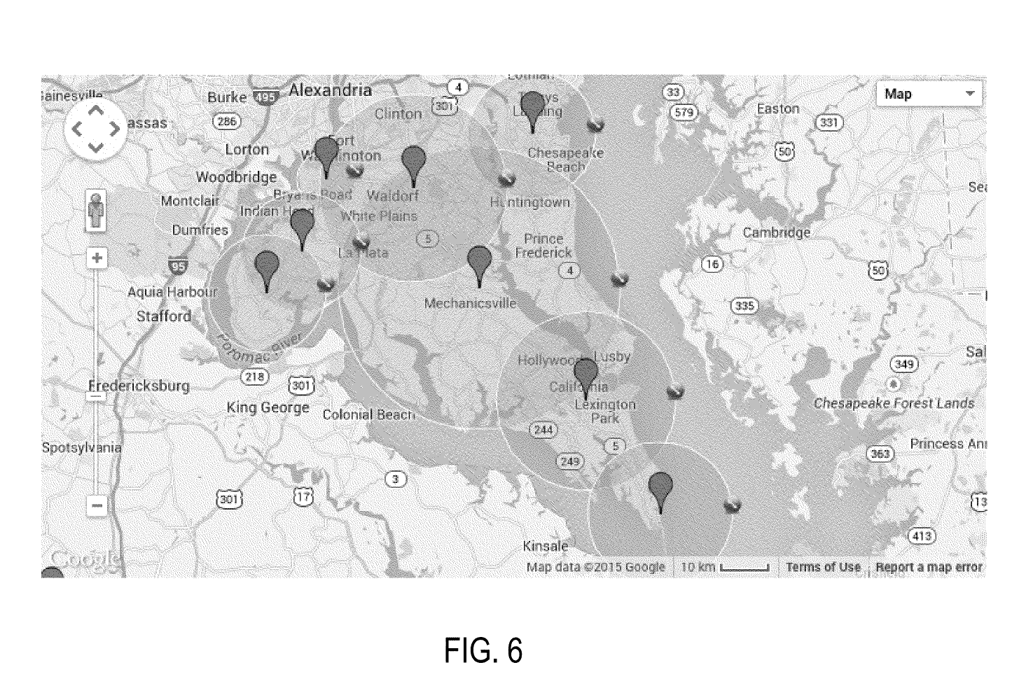

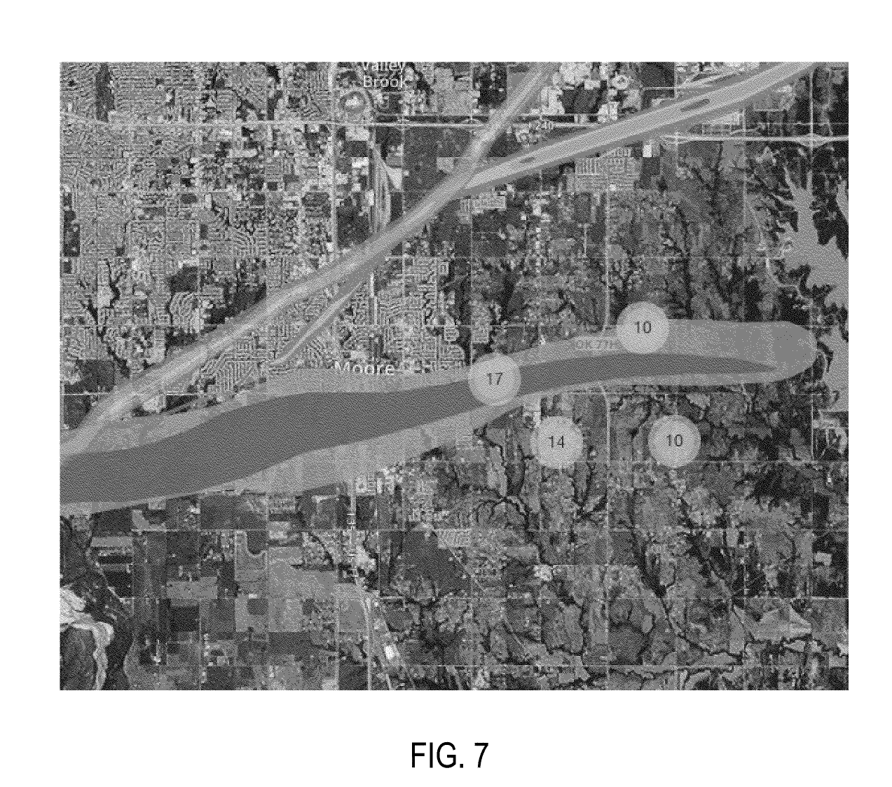

FIG. 5 is a flowchart illustrating selected steps of the method described in FIG. 4 in more detail; and FIGS. 6 and 7 each show heat maps illustrating geolocation principles of the exemplary method. Referring to FIGS. 5 through 7, selected steps of the example method 400 are described in more detail. Initially, a poster or user types a post (S405) on a social media source (e.g., social media website on a distributed social media network). As previously described, the social media source is continually scrubbed (S410) by the SCRBR algorithm to search for the social media posting posted by the poster. In particular, as part of scrubbing the SCRBR algorithm is looking for specific or predetermined keywords (S415) in the metadata in the content of the post.

The SCRBR algorithm then analyzes metadata of the social media posting (S420). As part of this analysis, the algorithm queries whether or not the post contains the predetermined keywords (S422). In parallel, the SCRBR algorithm runs a test (S424), based on the content in the post, to determine what type of industry and potential subscriber clients thereof would be most applicable to serving the need of the poster, as indicated by the content in the post which triggered the scrubbing function. The test includes the algorithm pulling the geofence from the metadata contained in the post. In general, a geofence is a virtual barrier. Programs that incorporate geofencing allow an administrator to set up triggers so when a device enters (or exits) the boundaries defined by the administrator, a text message or email alert is sent. A geofence could be dynamically generated—as in a radius around a store or point location. Or a geofence can be a predefined set of boundaries, like school attendance zones or neighborhood boundaries. When a location-aware device of a location-based service (LBS) user (such as the poster on Twitter or Facebook), enters or exits a geofence, the device receives a generated notification. This notification might contain geolocation information about the poster or device used by the poster/user. The geofence notice may typically be sent to a mobile telephone or an email account.

The geofence data is used by the SCRBR algorithm embodied by method 400 to determine which subscriber client (in regard to proximity to the poster) to assign the SCRBR information parsed from the metadata of the post to. The geofence/geolocation data may be stored (and saved) in the at least one database of computer system 100 and/or in any of the hard disk drive 241, magnetic disk drive 221 that reads from or writes to magnetic disk 222, and optical disk drive 255 of computer 210 that reads from or writes to a removable, nonvolatile optical disk 226 such as a CD ROM, to assist in any heat map data that may be needed. Any generated heat maps are a product on the data side of things (“add-on” or a distinct other revenue stream). The generation of heat maps and associated data is tied into the real time information that the SCRBR algorithm as embodied by method 400 obtains from social media, and may be used for review by the subscriber clients, i.e., if a subscriber client wanted to see how many “jobs” they received from the SCRBR service in relation to the number/concentrated area of social media posts (see simulated images in FIGS. 6 and 7).

If the output of S422 is “NO”, the process ends. If the output of S422 is “YES” then the weighted score calculation (S430) is performed. In particular, the metadata of the post is run through a weighted equation to determine if the post is worthy of an auto-response from the assigned or selected subscribing client. As part of this calculation, the discovered predetermined keywords in the content of the post are evaluated against stored databases of positive and negative keywords that directly affect the calculated score.

For example, positive keywords or phrases that generate a positive number as part of the weighted score calculation, to be stored in a database (such as at least one database 112 of computer system 100) may include but are not limited to “flood”, “flooded”, “basement”, “burst”, “pipe”, “broken”, “sump pump”, “sump”, “pump”, “sewage”, “backup”. Light negative keywords stored in at least one database 112 may include but are not limited to words having a common slang but with a number of different meanings, but which also may be a part of a legitimate lead. Such words if parsed are assigned the least subtracted/negative number in the weighted score calculation. These could include curse words used in place of legitimate positive keywords or phrases such as “sewage”, “toilet backup”, the word “bitch” as a slang term to represent a situation, i.e., “Son of a bitch, my basement is flooded”.

Heavy negative keywords would be something that could remove a social media post of a potential poster/customer from access by a subscriber client of the SCRBR service. Such words may include notorious curse words such as the seven expletive words banned by the FCC.

The calculated weighted score, which is a number, is then compared to filter criteria (S440), more specifically to a threshold value representative of the filter criteria. In an example, the threshold value is 7.65; the calculated weighted score must meet or exceed this number to pass the filter criteria. If it does not (output of S440 is “NO”), another margin of error sub-analysis (at S447) is performed and either the client is assigned (S445) or the process ends (S470); otherwise the score passes the filter criteria (output of S440 is “YES”), and the SCRBR algorithm then assigns or selects (S450) a primary subscriber client (e.g., service provider) from the group of clients subscribing to the SCRBR service to initiate contact at S460.

As previously discussed in general, geofence data is employed to select the subscribed client from a group thereof. The subscriber client is assigned after the industry is determined. The subscriber client is assigned the lead based on the subscriber client's “user profile” built when they register with the SCRBR service. For example, a service provider might fill out their information and update their profile to accept any leads (within their industry or industries) within a territory or territories that they selected. If there are multiple clients in that territory, the metadata scrubbed by the SCRBR algorithm will be sent to all of them.

The industry and subscriber client to be assigned the lead is determined from the social media post (this could also include multiple industries), and may be implemented as follows:
1) Geofence area of social media post hits SCRBR algorithm;
2) SCRBR algorithm searches against User Profiles in that state within database 132 where the poster is;
3) SCRBR algorithm compiles list of clients in that area; and
4) there is a rotating order of which subscriber client gets that certain lead. Rotation could be based on seniority; i.e., if client A is up to get the lead, the SCRBR algorithm pulls that client's social media account information (which is updated and which the client permits the SCRBR service the right to use on their behalf), and then generates one or a set auto-response based on the client's standards to the poster.

Upon selection of the subscriber client, a test is run for the set auto-generated response (S452). In an example, each subscriber client may have their own personalized response(s), i.e., where a Texas-based subscriber client is assigned to respond to a hit for sewage damage by a poster in the Texas area, the auto-generated response might include a salutation of something like “Howdy”, whereas a salutation of a Baltimore-based subscriber client in response to a Baltimore-based post might be “Hi hon!”. The selected subscriber client generates the desired auto-response (S460) in reply to the poster's tweet (post) to initiate contact therewith. These processing steps continually repeat (S480) for each social media posting scrubbed from a social media source.

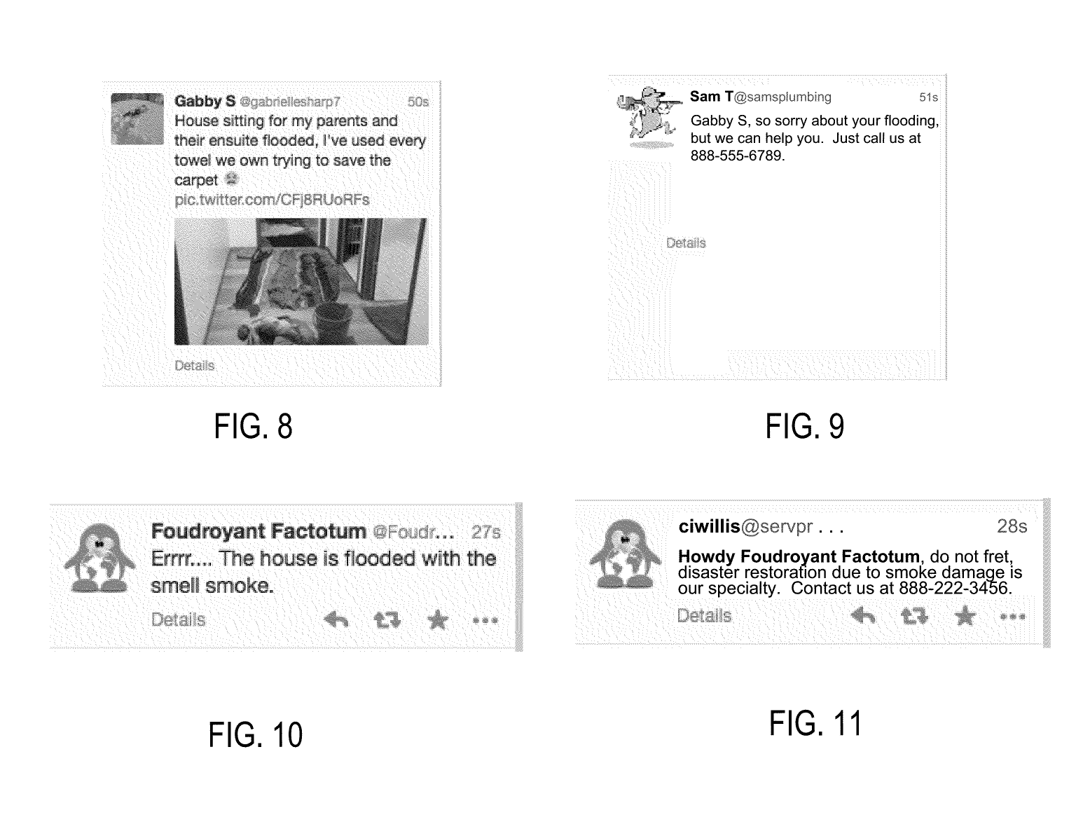

FIGS. 8 through 11 show pictures of a chat box illustrating an example post on TWITTER evaluated by the SCRBR algorithm, and that of an example chat box illustrating an example auto-generated response by the subscriber client selected or assigned by the SCRBR algorithm to address the scrubbed post. As can be seen by these two sets of figures, in response to a scrubbed social media posting, the calculated weighted score of which having passed the filter criteria, the assigned subscriber client generates an auto-response to initiate contact.

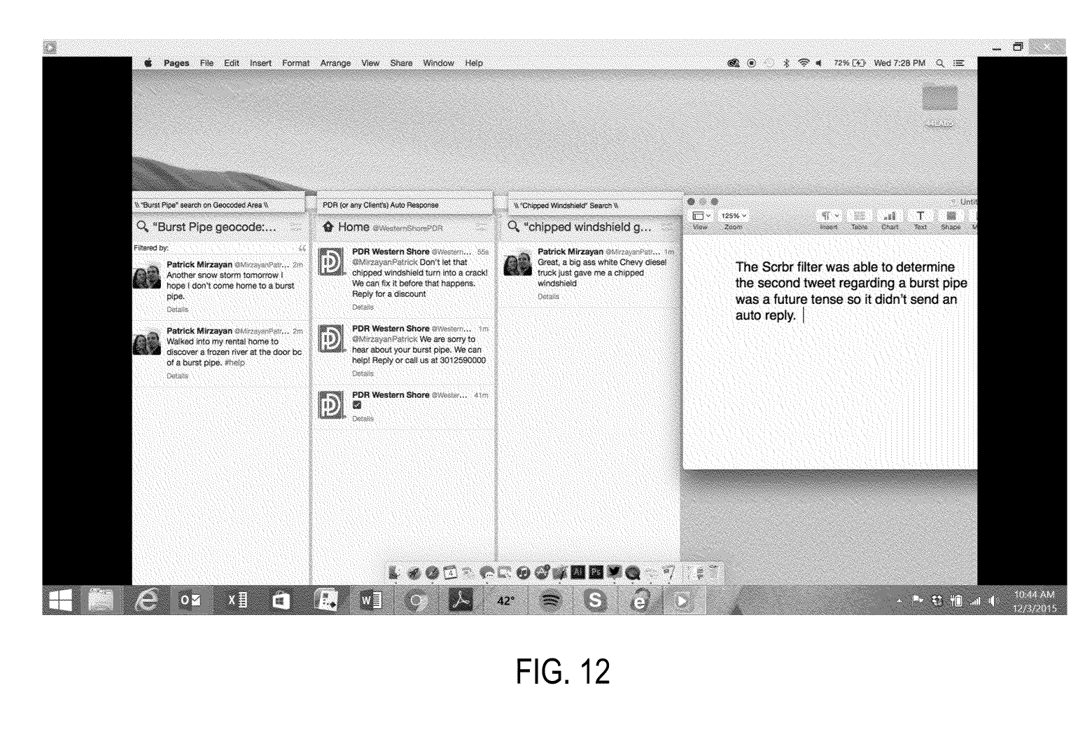

FIG. 12 is a screenshot of another timeline example using the SCRBR application to address separate burst pipe and broken windshield tweets. Here, the third from left chat box shows an example post on TWITTER (cracked windshield keyword), with a 55 sec delay before the auto-generated response by the assigned subscriber client is sent to the poster. Additionally, a second tweet, see the left-most chat box, shows an example tweet with a pipe burst keyword that is immediately evaluated by the SCRBR algorithm, with a subsequent chat box showing the auto-generated response by the subscriber client selected or assigned by the SCRBR algorithm to address the scrubbed water damage post. Note that no auto-generated response is sent in reply to the subsequent tweet on the water damage event, as the tweet was future tense. This further illustrates the sensitivity of the SCRBR algorithm.

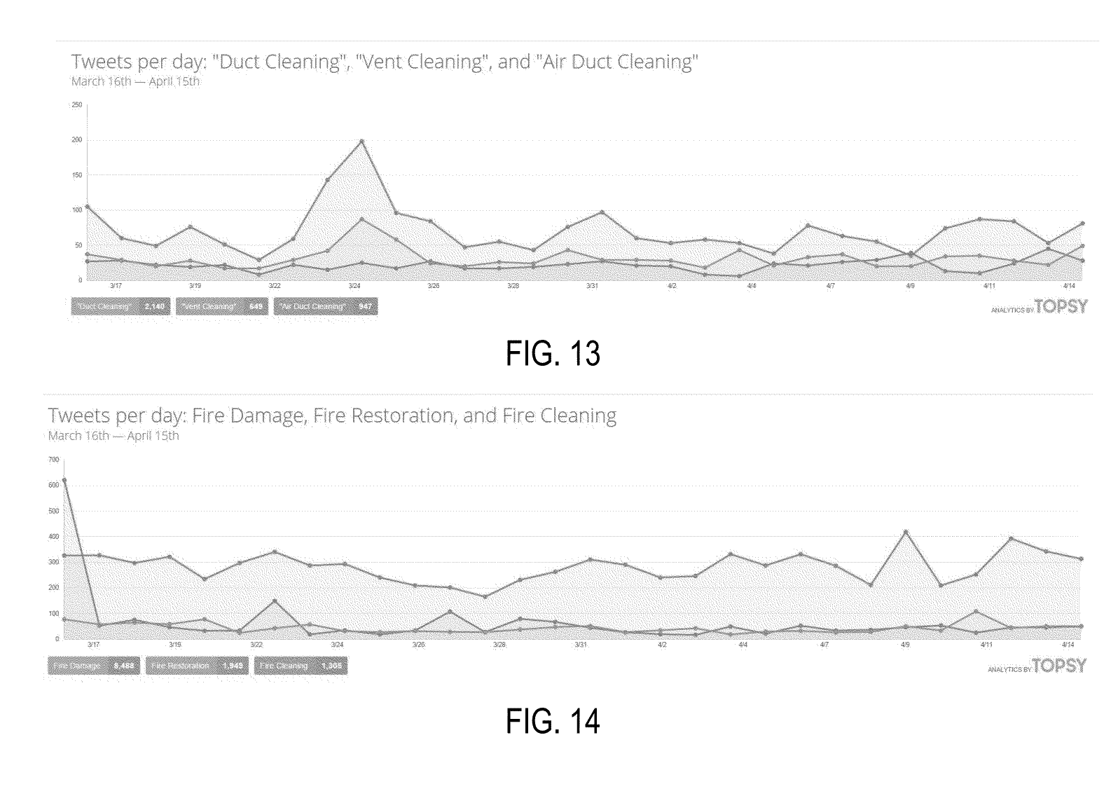

FIGS. 13 through 17 are various graphs of a one month snapshot of tweets in spring 2015 which tracks the number of selected keywords discovered daily therein, as tracked by the Twitter analytics vendor TOPSY® LABS, Inc., which until bought by APPLE and subsequently shut down in December 2015, was an independent social search and analytics company based in San Francisco, Calif. A certified TWITTER partner, TOPSY has maintained a comprehensive index of tweets, numbering in hundreds of billions, dating back to TWITTER's inception in 2006, and offered products to search, analyze and draw insights from conversations and trends on various public social websites.

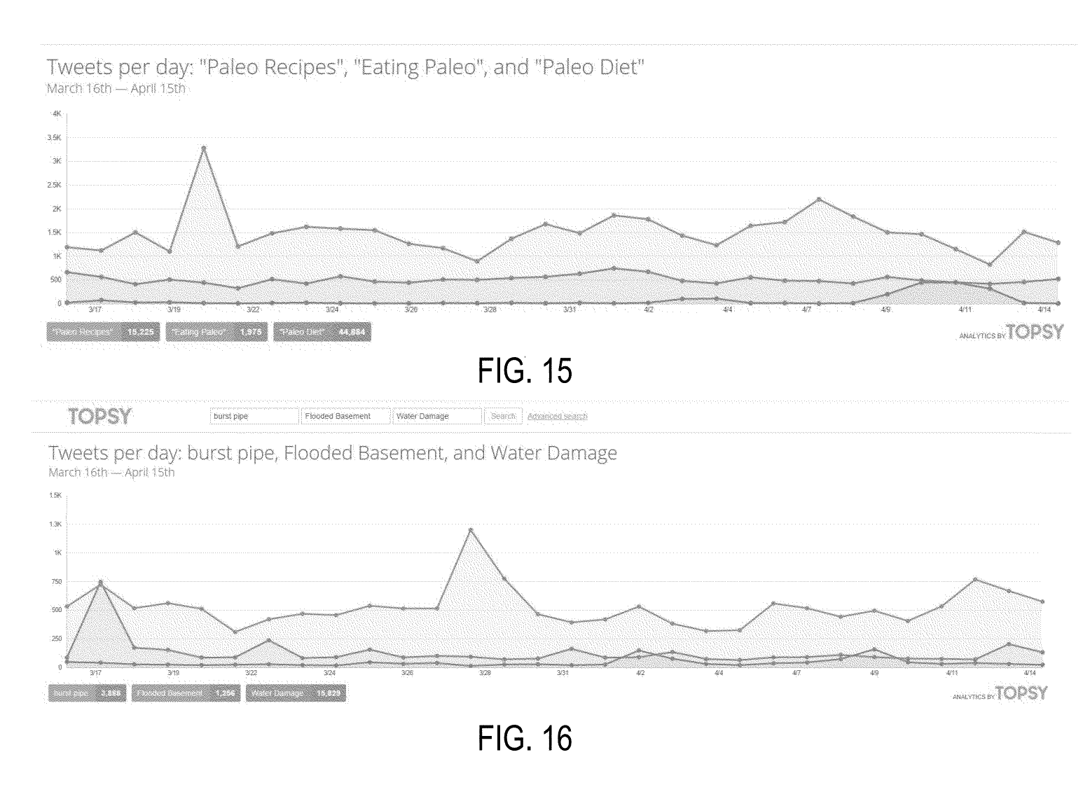

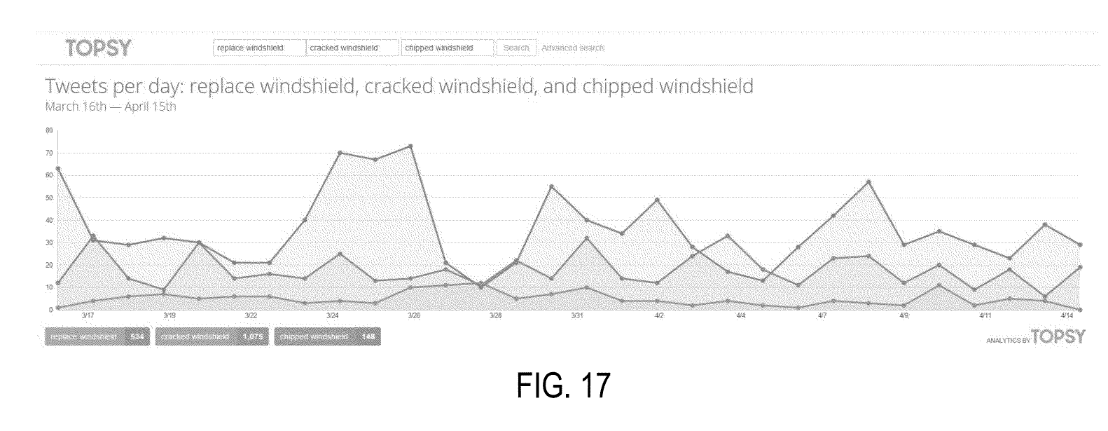

As shown, each graph is directed to the tracking of different keywords in tweets, such as those related to duct cleaning (FIG. 13), fire damage-related keywords (FIG. 14), Paleo-related keywords (FIG. 15, to illustrate a differentiator), water damage-related keywords (FIG. 16), and windshield damage-related keywords (FIG. 17). Accordingly, in these snapshots, TOPSY determined that in this one-month snapshot, for just a single social media source (TWITTER) and for merely a handful of insurance loss-type events, there were well over 38,000 relevant tweets that had some kind of keyword therein that might be highly relevant to a subscribing client of the SCRBR service.

The present invention, in its various embodiments, configurations, and aspects, includes components, methods, processes, systems and/or apparatuses substantially as depicted and described herein, including various embodiments, sub-combinations, and subsets thereof. Those of skill in the art will understand how to make and use the present invention after understanding the present disclosure. The present invention, in its various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The embodiments described herein may be implemented in digital electronic circuitry, or in computer hardware, firmware, software, or in combinations of them. The embodiments can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computer system. A computer program can be deployed to be executed on one computer or on multiple computers at one site or distributed across multiple sites and interconnected by a communication network.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of any ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

It is to be understood that the foregoing description is intended to illustrate and not to limit the scope of the invention, which is defined by the scope of the appended claims. Other embodiments are within the scope of the following claims.

1. A method, comprising:
continually scrubbing a social media source to search for a social media posting posted by a poster thereon,
analyzing metadata in the social media posting,
calculating a score based on the analyzed metadata, the score related to whether the social media posting passes filter criteria,
comparing the calculated score to the filter criteria, and, on condition that the score passes the filter criteria, and
assigning a subscribing client selected from a group of subscribing clients to generate an auto-response to the poster so as to initiate contact therewith, the generated auto-response addressing content in the social media posting,
wherein the scrubbing, analyzing, calculating, comparing, and assigning steps are performed by computer software adapted to run on computer hardware.

2. The method of claim 1, wherein the subscribing client is a service-oriented business related to any of disaster restoration, auto glass repair, auto repair, home improvement, real estate sales, and appliance repairs.

3. The method of claim 1, wherein content in the social media posting is related to an insurance loss event.

4. The method of claim 3, wherein the insurance loss event is selected from a group of events where damage is caused, the group of events comprising fire, water, sewage, smoke, mold, vandalism, trauma, and structural failures, wind, fallen trees, lightening, earthquakes, hurricanes, snow loads, hail, ice dams, and other acts of God.

5. The method of claim 1, wherein analyzing metadata of the social media posting further includes searching for selected or predetermined keywords in the content of the social media posting to evaluate against stored databases of positive and negative keywords that directly affect the calculated score.

6. The method of claim 1, wherein if the calculated score does not pass the filter criteria but is determined to be within a given margin of error value, assigning further includes assigning a lower-priority subscribing client from the group to generate an auto-response to the poster.

7. A set of machine readable instructions and associated data, stored on a storage device in a manner more persistent than a signal in transit, the set comprising:
a fetch posting module programmed to continually scrub a social media source to search for a social media posting posted by a poster thereon,
an analysis module programmed to analyze metadata of the social media posting, to calculate a score based on the analyzed metadata, the score related to whether the social media posting passes filter criteria, to compare the calculated score to the filter criteria, and, on condition that the score passes the filter criteria,
an assignment module programmed to assign a subscribing client selected from a group of subscribing clients to generate an auto-response to the poster so as to initiate contact therewith, the generated auto-response addressing content in the social media posting.

8. The set of claim 7, wherein the subscribing client is a service-oriented business related to any of disaster restoration, auto glass repair, auto repair, home improvement, real estate sales, and appliance repairs.

9. The set of claim 7, wherein content in the social media posting is related to an insurance loss event.

10. The set of claim 9, wherein the insurance loss event is selected from a group of events where damage is caused, the group of events comprising fire, water, sewage, smoke, mold, vandalism, trauma, and structural failures, wind, fallen trees, lightening, earthquakes, hurricanes, snow loads, hail, ice dams, and other acts of God.

11. The set of claim 7, wherein the analysis module further is programmed to search for selected or predetermined keywords in the content of the social media posting to evaluate against stored databases of positive and negative keywords that directly affect the calculated score.

12. A computer system, comprising:
a processing hardware set, and
a computer readable storage device medium, wherein
the processing hardware set is structured, connected or programmed to run program instructions stored on the computer readable storage medium instructions and associated data, the program instructions including:
a fetch posting module programmed to continually scrub a social media source to search for a social media posting posted by a poster thereon,
an analysis module programmed to analyze metadata of the social media posting, to calculate a score based on the analyzed metadata, the score related to whether the social media posting passes filter criteria, to compare the calculated score to the filter criteria, and, on condition that the score passes the filter criteria,
an assignment module programmed to assign a subscribing client selected from a group of subscribing clients to generate an auto-response to the poster so as to initiate contact therewith, the generated auto-response addressing content in the social media posting.

13. The system of claim 12, wherein the subscribing client is a service-oriented business related to any of disaster restoration, auto glass repair, auto repair, home improvement, real estate sales, and appliance repairs.

14. The system of claim 12, wherein content in the social media posting is related to an insurance loss event.

15. The system of claim 14, wherein the insurance loss event is selected from a group of events where damage is caused, the group of events comprising fire, water, sewage, smoke, mold, vandalism, trauma, and structural failures, wind, fallen trees, lightening, earthquakes, hurricanes, snow loads, hail, ice dams, and other acts of God.

16. The system of claim 12, wherein the analysis module further is programmed to search for selected or predetermined keywords in the content of the social media posting to evaluate against stored databases of positive and negative keywords that directly affect the calculated score.

17. The system of claim 1, wherein if the score calculated by the analysis module does not pass the filter criteria but is determined to be within a given margin of error value, the assignment module is adapted to assign a lower-priority subscribing client from the group to generate an auto-response to the poster.
